(19) United States
(12) Patent Application Publication
(10) Pub. No.: US 2019/0315164 A1
(43) Pub. Date: Oct. 17, 2019

(54) PNEUMATIC TIRE

(71) Applicant: TOYO TIRE CORPORATION, Itami-shi (JP)

(72) Inventor: Kouichi Takita, Itami-shi (JP)

(73) Assignee: TOYO TIRE CORPORATION, Itami-shi (JP)

(21) Appl. No.: 16/367,688

(22) Filed: Mar. 28, 2019

(30) Foreign Application Priority Data
Apr. 11, 2018 (JP) 2018-075871

(51) Int. Cl. B60C 13/02

(52) U.S. Cl. CPC B60C 13/02; B60C 2200/14

(57) ABSTRACT

A pneumatic tire has a protrusion provided on a buttress portion. The protrusion includes a side wall protruding from a surface of the buttress portion, and a top wall provided at a distal end of the side wall. The side wall includes portions facing each other in a tire circumferential direction. Each of the portions is inclined in the tire circumferential direction such that a protrusion height that is a distance of the projection from the surface of the buttress portion gradually decreases from the top wall toward the surface of the buttress portion. An inclination angle of each of the portions in the tire circumferential direction to the surface of the buttress portion gradually decreases from the inside to the outside in the tire radial direction.

### CROSS-REFERENCE TO RELATED APPLICATIONS

This application claims priority of Japanese Patent Application No. 2018-075871 filed on Apr. 11, 2018, the content of which is incorporated herein by reference.

### BACKGROUND OF THE INVENTION

### Technical Field

The present invention relates to a pneumatic tire.

### Related Art

A pneumatic tire which includes protrusions on a buttress portion is known (see JP 2013-82262 A and JP 2015-168301 A). Generally, protrusions of this type a provided to improve traction performance during traveling on rough unpaved roads or bad roads such rocky roads.

### SUMMARY

Modes known as external damage or failure caused during traveling on bad roads include a tear of the buttress portion at bases of the protrusions.

There is still room for improvement, however, over protrusions provided in buttress portions of conventional pneumatic tires, including those disclosed in JP 2013-82262 A and JP 2015-168301 A, for increasing external damage resistance of the protrusions while securing traction performance.

An object of the present invention is to improve external damage resistance of protrusions provided in a buttress portion of a pneumatic tire while securing traction performance.

One aspect of the present invention provides a pneumatic tire including a protrusion provided on a buttress portion. The protrusion includes a side wall protruding from a surface of the buttress portion, and a top wall provided at a distal end of the side wall. The side wall includes a first portion that is one of portions facing each other in a tire circumferential direction. The first portion is inclined in the tire circumferential direction such that a protrusion height that is a distance of the protrusion from the surface of the buttress portion gradually decreases from the top wall toward the surface of the buttress portion. An inclination angle of the first portion in the tire circumferential direction with respect to the surface of the buttress portion gradually decrease from the inside to the outside in a tire radial direction.

The protrusion provided on the buttress portion improves traction performance.

Improvement of external damage resistance of the protrusion by reduction of movement of the protrusion at the time of kicking is achievable by setting a rotation direction of the pneumatic tire such that the first portion inclined in the tire circumferential direction comes to the kicking side.

External force acting on the protrusion at the time of kicking tends to become larger on the outside than on the inside in the tire radial direction. Accordingly, improvement of external damage resistance of the protrusion by more effective reduction of movement of the protrusion at the time of kicking is achievable by setting an inclination angle of the first portion in the tire circumferential direction such that the inclination angle gradually decreases from the inside to the outside in the tire radial direction, i.e., by designating a relatively small angle in the tire circumferential direction as the inclination angle of the first portion on the outside in the tire radial direction.

The inclination angle of the first portion may be set not less than 10 degrees and not more than 90 degrees.

The side wall may include a second portion facing the first portion in the tire circumferential direction. The second portion may be inclined in the tire circumferential direction such that the protrusion height gradually decreases from the top wall toward the surface of the buttress portion. An inclination angle of the second portion in the tire circumferential direction with respect to the surface of the buttress portion may gradually decrease from the inside to the outside in the tire radial direction.

This configuration effectively reduces movement of the protrusion at the time of kicking, thereby improving external damage resistance of the protrusion in each of two rotation directions designated as the rotation direction of the pneumatic tire.

The side wall may include a second portion facing the first portion in the tire circumferential direction. The second portion may have a flat shape that expands while crossing the surface of the buttress portion at right angles.

A linear edge is defined by the second part having a flat shape, and by the top wall. Accordingly, traction performance further improves by setting the rotation direction of the pneumatic tire such that the second portion comes to a treading side. Moreover, in this setting of the rotation direction, the inclined first portion consequently comes to the kicking side. Accordingly, external damage resistance on the kicking side improves.

Each of an outer end and an inner end of the protrusion in the tire radial direction may be disposed at a height in a range not less than 0.1 and not more than 1.0 times a tire height from an innermost end of the pneumatic tire.

The pneumatic tire may include a block that extends from a tread portion to the buttress portion beyond a tread end. The protrusion may be disposed such that an outer end of the protrusion is located adjacent to an inner end of the block in the tire radial direction.

The block may include a first block having an edge that is defined by a portion extending in the tire width direction and a portion extending in the tire radial direction, and that is located at a first position. The block may include a second block having an edge that is defined by a portion extending in the tire width direction and a portion extending in the tire radial direction, and that is located at a second position closer to a center in the tire width direction than the first position is. The first block and the second block may be alternately arranged in the tire circumferential direction.

A step is formed in the tire circumferential direction by the edge of the first block and the edge of the second block. Traction performance further improves by cooperative operation of the first and second blocks forming this step, and the protrusion.

According to the present invention, external damage resistance of a protrusion provided on a buttress portion of a pneumatic tire improves while securing traction performance.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to a first embodiment of the present invention;

FIG. 2 is a partial developed view of a tread portion and a buttress portion of the pneumatic tire according to the first embodiment of the present invention;

FIG. 3 is a partial side view of the buttress portion according to the first embodiment of the present invention;

FIG. 4A is a perspective view of a protrusion according to the first embodiment of the present invention;

FIG. 4B is a view of the protrusion according to the first embodiment of the present invention as viewed in a tire width direction;

FIG. 4C is a view of the protrusion according to the first embodiment of the present invention as viewed from the outside in a tire radial direction;

FIG. 4D is a view of the protrusion according to the first embodiment of the present invention as viewed from the inside in the tire radial direction;

FIG. 5A is a perspective view of a protrusion according to a second embodiment of the present invention;

FIG. 5B is a view of the protrusion according to the second embodiment of the present invention as viewed in the tire width direction;

FIG. 5C is a view of the protrusion according to the second embodiment of the present invention as viewed from the outside in a tire radial direction; and

FIG. 5D is a view of the protrusion according to the second embodiment of the present invention as viewed from the inside in the tire radial direction.

### DETAILED DESCRIPTION OF EMBODIMENTS

An embodiment according to the present invention is hereinafter described with reference to the accompanying drawings. It should be noted that the following description is essentially presented by way of example, and not intended to limit the present invention, applicable ranges of the present invention, or purposes of use of the present invention. In addition, the accompanying drawings are only schematic figures, and do not show actual ratios or the like of respective dimensions.

In each of the figures, an X direction corresponds to a tire radial direction, a Y direction corresponds to a tire circumferential direction, and a Z direction corresponds to a tire width direction.

### First Embodiment

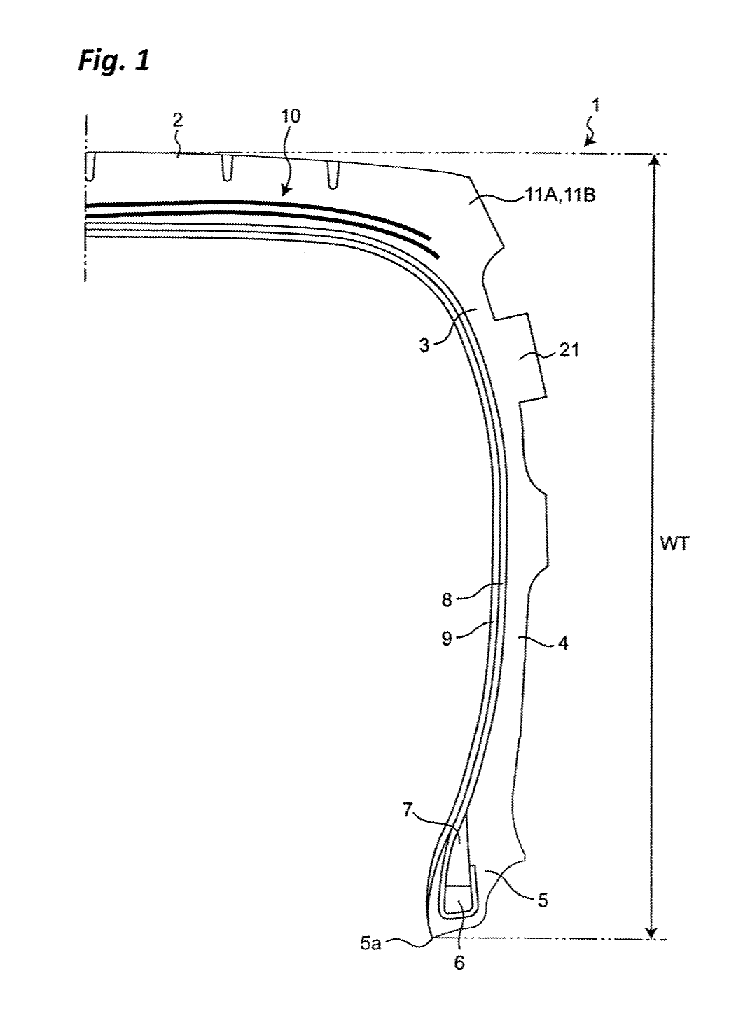

Referring to FIG. 1, a pneumatic tire 1 includes a tread portion 2, a pair of sidewall portions 4 extending from both ends of the tread portion 2 in the tire width direction toward the inside in the tire radial direction in the tire width direction via buttress portions 3 as transition regions, and a pair of bead portions 5 disposed at inner ends of the pair of sidewall portions 4 in the tire radial direction. Each of the bead portions 5 includes a bead core 6 having an annular shape, and a bead filler 7 disposed outside the bead core 6 in the tire radial direction.

A carcass plus 8 having a toroidal shape is disposed between the pair of bead portions 5 inside the tread portion 2 and the sidewall portions 4 in the tire radial direction. An inner liner 9 is disposed inside the carcass plus 8 in the tire radial direction. A belt layer 10 is provided in the tread portion 2 outside the carcass plus 8 in the tire radial direction.

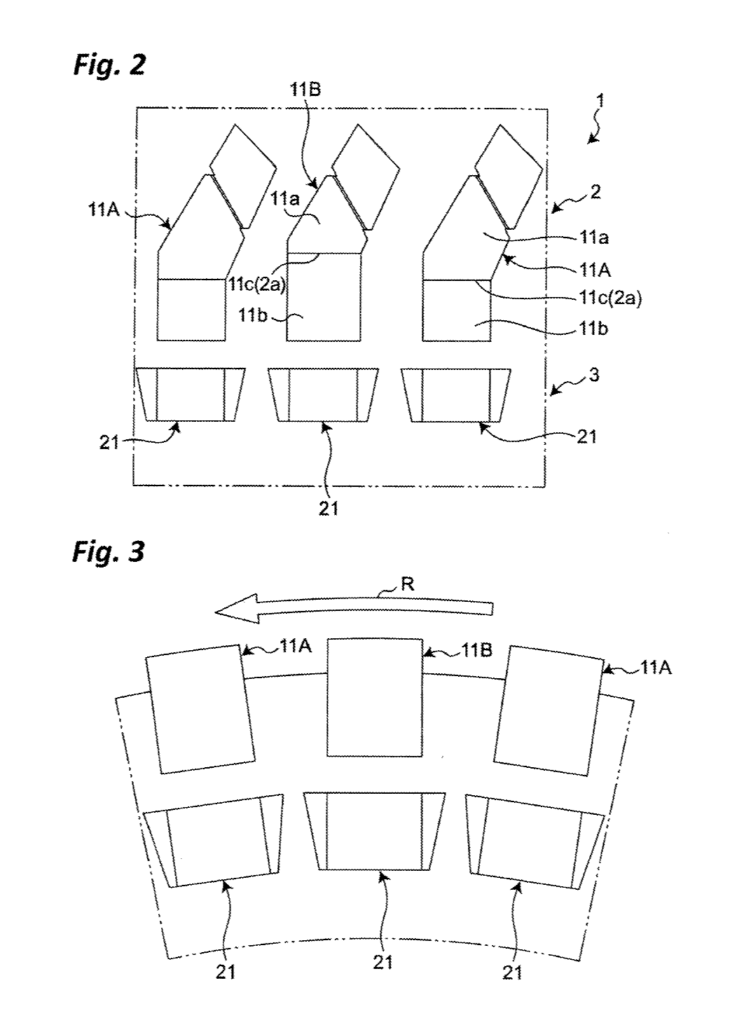

Referring to both FIGS. 2 and 3, blocks 11A and 11B provided in a region outside the tread portion 2 in the tire width direction extend from the tread portion 2 to the buttress portion 3. The blocks 11A and 11B are alternately arranged in the tire circumferential direction. Each of the blocks 11A and 11B includes a portion 11a extending in the tire width direction in the tread portion 2, and a portion 11b extending in the tire radial direction in the buttress portion 3. The respective portions 11a and 11b define an edge 11c. According to the present embodiment, the edge 11c constitutes a tread end 2a.

A position of the edge 11c of the block 11B in the tire width direction (second position) is located closer to the center in the tire width direction than a position of the edge 11c of the block 11A in the tire width direction (first position) is. Accordingly, the edge 11c of the block 11A and the edge 11c of the block portion 11B form repetitive steps in the tire circumferential direction (staggered shoulder structure).

Protrusions 21 protruding in the tire width direction are provided adjacent to the respective blocks 11A and 11B in the buttress portion 3. The position and size of each of the protrusions 21 are not limited to those specified in the present embodiment. More specifically, the position and the size of each of the protrusions 21 may be set such that each of an outer end and an inner end of the protrusion 21 in the tire radial direction is located at a height in a range not less than 0.1 and not more than 1.0 times a tire height WT from an innermost end 5a of the bead portion 5, which end is an innermost end of the pneumatic tire 1.

The protrusions 21 provided on the buttress portions 3 improve traction performance. Particularly according to the present embodiment, the protrusions 21 are provided adjacent to the blocks 11A and 11B where the edges 11c form repetitive steps in the tire circumferential direction as described above. Traction performance effectively improves by cooperative operation of the blocks 11A and 11B forming the steps, and the protrusions 21.

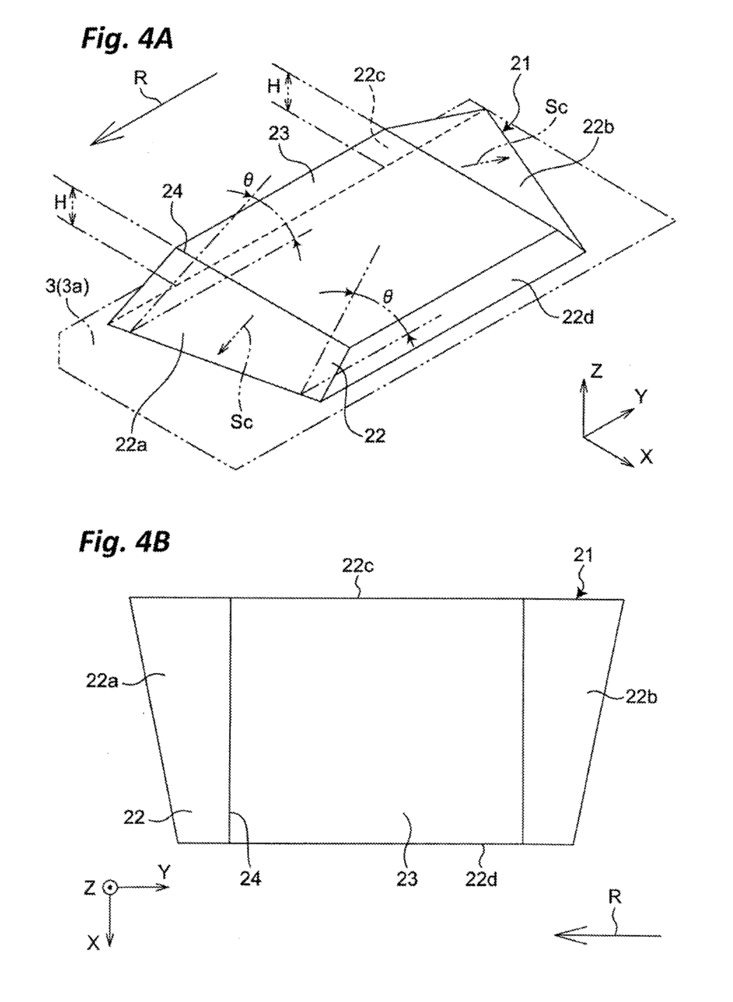

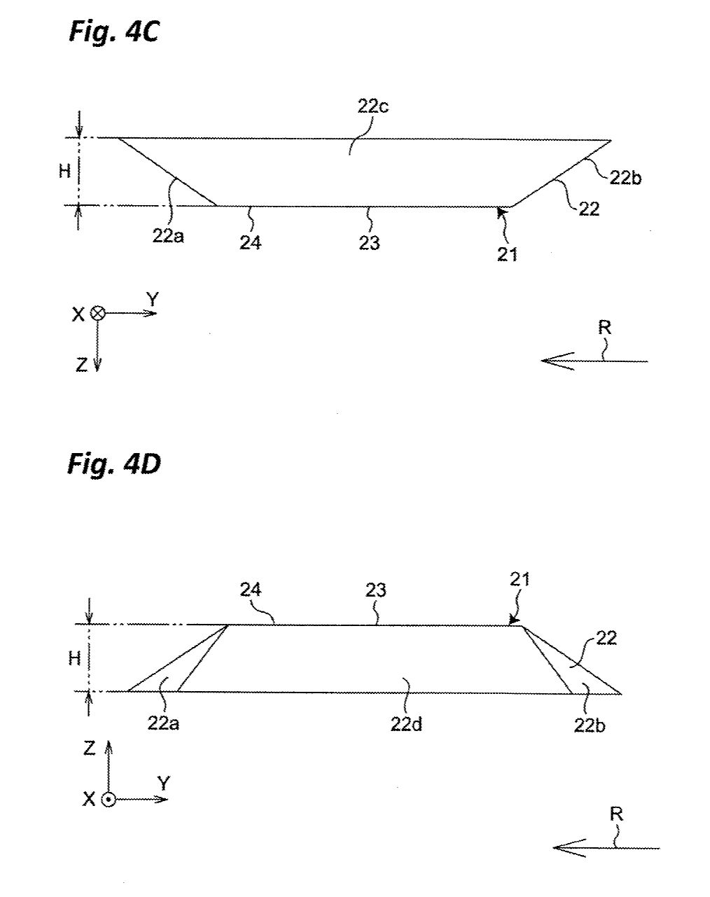

Referring to FIG. 4A to 4D, the protrusion 21 includes a side wall 22 protruding in the tire width direction from a surface 3a of the buttress portion 3, and a top wall 23 provided at a distal end of the side wall 22. An edge 24 is defined by the side wall 22 and the top wall 23.

According to the present embodiment, the top wall 23 is a flat surface having a rectangular shape as viewed in the tire width direction. Moreover, according to the present embodiment, a protrusion height H, which is a distance of the protrusion from the surface 3a of the buttress portion 3, is constant throughout the top wall 23. More specifically, the top wall 23 has no inclination in both the tire radial direction and the tire radial direction, and is parallel to the surface 3a of the buttress portion 3.

The side wall 22 includes a pair of portions 22a and 22b facing each other in the tire circumferential direction, and portions 22c and 22d facing each other in the tire radial direction. The portion 22c constitutes an outer end of the protrusion 21 in the tire radial direction, while the portion 22d constitutes an inner end of the protrusion 21 in the tire radial direction.

According to the present embodiment, each of the pair of portions 22c and 22d included in the side wall 22 and facing each other in the tire radial direction is a flat surface which extends while crossing the surface 3a of the buttress portion 3 and the tire radial direction at right angles. In addition, according to the present embodiment, each of the portions 22c and 22d has an isosceles trapezoidal shape. A lower base of the isosceles trapezoidal shape constituting the portion 22c disposed on the outside in the tire radial direction is longer than a lower base of the isosceles trapezoidal shape constituting the portion 22d disposed on the inside in the tire radial direction.

According to the present embodiment, each of the pair of portions 22a and 22b included in the side wall 22 and facing each other in the tire circumferential direction is a flat surface, and inclined in the tire circumferential direction such that the protrusion height H gradually decreases from the top wall 23 toward the surface 3a of the buttress portion 3. The direction of this inclination in the tire circumferential direction is conceptually indicated by arrows Sc in FIG. 4A.

According to the pair of portions 22a and 22b included in the side wall 22 of the protrusion 21 and facing each other in the tire circumferential direction, an inclination angle θ of each of the pair of portions 22a and 22b in the tire circumferential direction with respect to the surface 3a of the buttress portion 3 gradually decreases from the inside to the outside in the tire radial direction. For example, the inclination angle θ of each of the portions 22a and 22b in the vicinity of the inner end of the protrusion 21 in the radial direction is sufficiently smaller than the inclination angle θ of each of the portions 22a and 22b in the vicinity of the outer end of the protrusion 21 in the tire radial direction. The inclination angle θ may be set not less than 10 degrees and not more than 90, for example.

According to knowledge of the present inventor, failure or external damage of the protrusion provided in the buttress portion is chiefly produced as a crack at a boundary between the side portion on the kicking side and the surface of the buttress portion. When the rotation direction of the pneumatic tire 1 is the direction indicated by an arrow R, the portion 22b, which is one of the pair of portions 22a and 22b included in the side wall 22 of the protrusion 21 and facing each other in the tire circumferential direction, comes to the kicking side. When the rotation direction of the pneumatic tire 1 is the direction opposite to the arrow R, the portion 22a comes to the kicking side. As described above, each of the pair of portions 22a and 22b is inclined in the tire circumferential direction such that the protrusion height H gradually decreases from the top wall 23 toward the surface 3a of the buttress portion 3. In the state that the portion 22a or the portion 22b on the kicking side is inclined in the tire circumferential direction, movement of the protrusion 21 at the time of kicking decreases. Accordingly, external damage resistance of the protrusion 21 improves.

External force acting on the protrusion 21 at the time of kicking tends to become larger on the outside than on the inside in the tire radial direction. Accordingly, improvement of external damage resistance of the protrusion by more effective reduction of movement of the protrusion at the time of kicking is achievable by setting the inclination angle θ in the tire circumferential direction, which is the inclination angle of each of the pair of portions 22a and 22b included in the side wall 22 of the protrusion 21 and facing each other in the tire circumferential direction, such that the inclination angle θ gradually decreases from the inside to the outside in the tire radial direction, i.e., by designating a relatively small angle in the tire circumferential direction as the inclination angle θ of the portions 22a and 22b on the outside in the tire radial direction.

According to the pneumatic tire 1 of the present embodiment as described above, external damage resistance of the protrusion 21 provided on the buttress portion 3 improves while securing traction performance.

### Second Embodiment

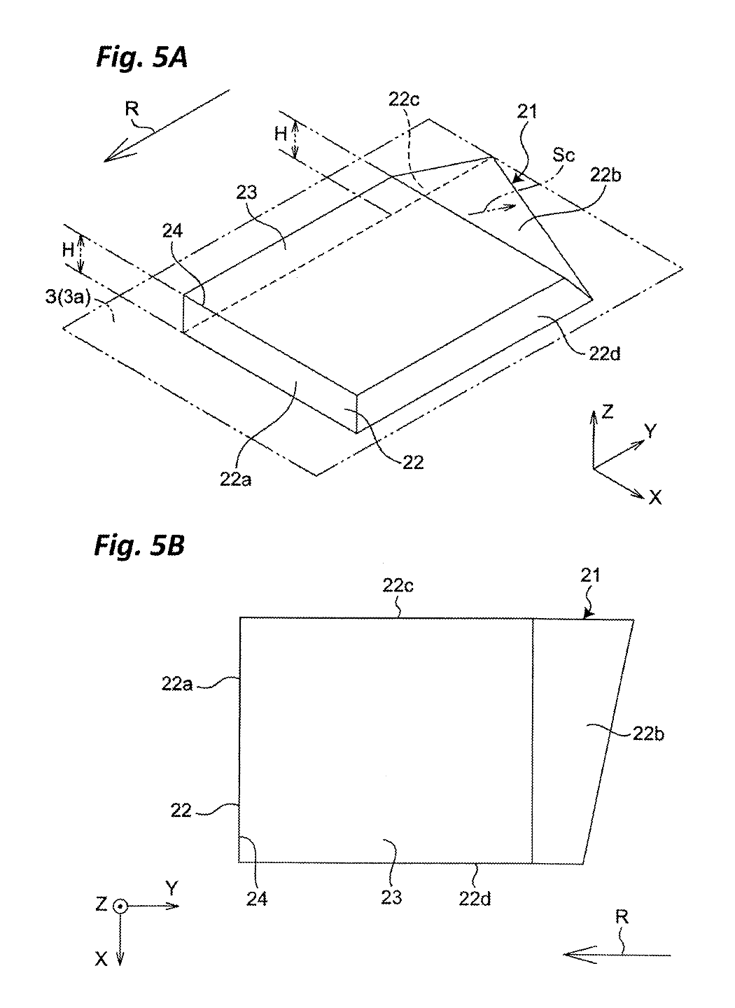

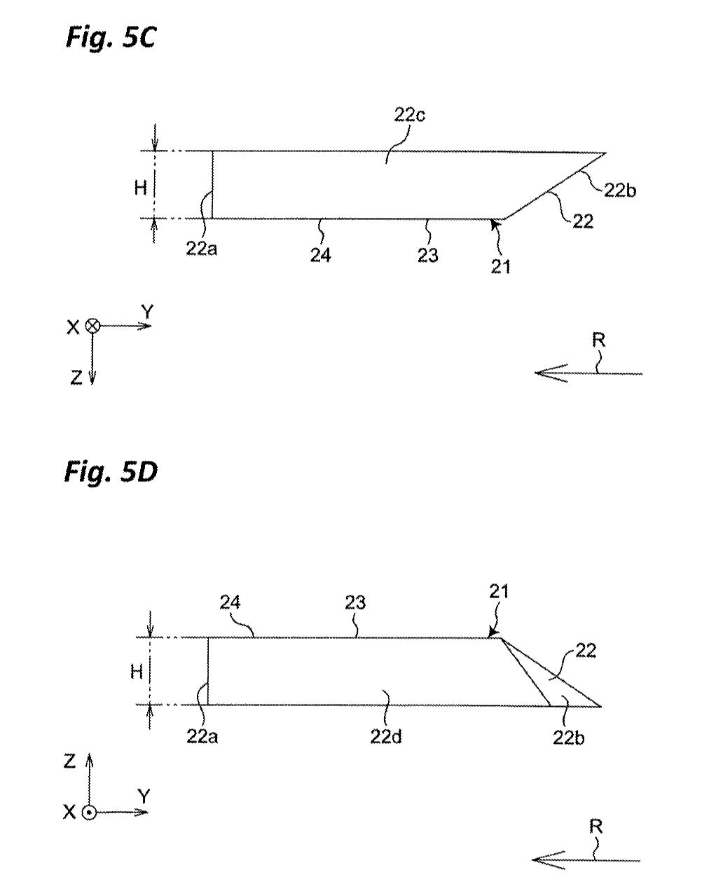

FIGS. 5A to 5D show the protrusion 21 according to a second embodiment of the present invention. Structures, actions, and functions not particularly mentioned in the present embodiment are similar to those of the first embodiment. In addition, elements identical or similar to the corresponding elements of the first embodiment are given identical reference numbers, and the description and figures relating to these elements of the first embodiment will be also referred to.

According to the present embodiment, the one portion 22b of the pair of portions 22a and 22b included in the side wall 22 of the protrusion 21 and facing each other in the tire circumferential direction is inclined in the tire circumferential direction such that the protrusion height H gradually decreases from the top wall 23 toward the surface 3a of the buttress portion 3 similarly to the first embodiment. Moreover, the inclination angle θ of the portion 22b in the tire circumferential direction with respect to the surface 3a of the buttress portion 3 gradually decreases from the inside to the outside in the tire radial direction.

The other portion 22a of the pair of portions 22a and 22b included in the side wall 22 of the protrusion 21 and facing each other in the tire circumferential direction is a flat surface which extends while crossing the tire circumferential direction and the surface 3a of the buttress portion 3 at right angles. The edge 24 defined by the side wall 22 and the top wall 23 in a region constituted by the portion 22a of the side wall 22 and by the top wall 23 has a linear shape extending in the tire radial direction as viewed in the tire width direction.

When the rotational direction of the pneumatic tire 1 is set to the direction indicated by the arrow R, the portion 22b of the side wall 22 of the protrusion 21 on the kicking side is inclined in the tire circumferential direction. In this case, the inclination angle θ of the portion 22b gradually decreases from the inside toward the outside in the tire radial direction. Accordingly, movement of the protrusion 21 at the time of kicking decreases, and therefore external damage resistance of the protrusion 21 improves. In this case, the portion 22a included in the side wall 22 and constituting a flat surface which crosses the tire circumferential direction and the surface 3a of the buttress portion 3 at right angles, i.e., a linear portion of the edge 23 comes to the treading side. Accordingly, traction performance further improves.

What is claimed is:

1. A pneumatic tire comprising a protrusion provided on a buttress portion, wherein
the protrusion includes
a side wall protruding from a surface of the buttress portion, and
a top wall provided at a distal end of the side wall,
the side wall includes a first portion that is one of portions facing each other in a tire circumferential direction,
the first portion is inclined in the tire circumferential direction such that a protrusion height that is a distance of the protrusion from the surface of the buttress portion gradually decreases from the top wall toward the surface of the buttress portion; and
an inclination angle of the first portion in the tire circumferential direction with respect to the surface of the buttress portion gradually decreases from the inside to the outside in a tire radial direction.

2. The pneumatic tire according to claim 1, wherein the inclination angle of the first portion is not less than 10 degrees and not more than 90 degrees.

3. The pneumatic tire according to claim 1, wherein
the side wall includes a second portion facing the first portion in the tire circumferential direction,
the second portion is inclined in the tire circumferential direction such that the protrusion height gradually decreases from the top wall toward the surface of the buttress portion, and
an inclination angle of the second portion in the tire circumferential direction with respect to the surface of the buttress portion gradually decreases from the inside to the outside in the tire radial direction.

4. The pneumatic tire according to claim 2, wherein
the side wall includes a second portion facing the first portion in the tire circumferential direction,
the second portion is inclined in the tire circumferential direction such that the protrusion height gradually decreases from the top wall toward the surface of the buttress portion, and
an inclination angle of the second portion in the tire circumferential direction with respect to the surface of the buttress portion gradually decreases from the inside to the outside in the tire radial direction.

5. The pneumatic tire according to claim 1, wherein
the side wall includes a second portion facing the first portion in the tire circumferential direction, and
the second portion has a flat shape that expands while crossing the surface of the buttress portion at right angles.

6. The pneumatic tire according to claim 2, wherein
the side wall includes a second portion facing the first portion in the tire circumferential direction, and
the second portion has a flat shape that expands while crossing the surface of the buttress portion at right angles.

7. The pneumatic tire according to claim 1, wherein each of an outer end and an inner end of the protrusion in the tire radial direction is disposed at a height not less than 0.1 and not more than 1.0 times a tire height from an innermost end of the pneumatic tire.

8. The pneumatic tire according to claim 2, wherein each of an outer end and an inner end of the protrusion in the tire radial direction is disposed at a height not less than 0.1 and not more than 1.0 times a tire height from an innermost end of the pneumatic tire.

9. The pneumatic tire according to claim 3, wherein each of an outer end and an inner end of the protrusion in the tire radial direction is disposed at a height not less than 0.1 and not more than 1.0 times a tire height from an innermost end of the pneumatic tire.

10. The pneumatic tire according to claim 4, wherein each of an outer end and an inner end of the protrusion in the tire radial direction is disposed at a height not less than 0.1 and not more than 1.0 times a tire height from an innermost end of the pneumatic tire.

11. The pneumatic tire according to claim 5, wherein each of an outer end and an inner end of the protrusion in the tire radial direction is disposed at a height not less than 0.1 and not more than 1.0 times a tire height from an innermost end of the pneumatic tire.

12. The pneumatic tire according to claim 6, wherein each of an outer end and an inner end of the protrusion in the tire radial direction is disposed at a height not less than 0.1 and not more than 1.0 times a tire height from an innermost end of the pneumatic tire.

13. The pneumatic tire according to claim 1, further comprising a block that extends from a tread portion to the buttress portion beyond a tread end,
wherein the protrusion is disposed such that an outer end of the protrusion is located adjacent to an inner end of the block in the tire radial direction.

14. The pneumatic tire according to claim 2, further comprising a block that extends from a tread portion to the buttress portion beyond a tread end,
wherein the protrusion is disposed such that an outer end of the protrusion is located adjacent to an inner end of the block in the tire radial direction.

15. The pneumatic tire according to claim 3, further comprising a block that extends from a tread portion to the buttress portion beyond a tread end,
wherein the protrusion is disposed such that an outer end of the protrusion is located adjacent to an inner end of the block in the tire radial direction.

16. The pneumatic tire according to claim 13, wherein
the block includes a first block having an edge that is defined by a portion extending in the tire width direction and a portion extending in the tire radial direction, and that is located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.

17. The pneumatic tire according to claim 14, wherein
the block includes a first block having an edge that is defined by a portion extending in the tire width direction and a portion extending in the tire radial direction, and that is located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.

18. The pneumatic tire according to claim 15, wherein
the block includes a first block having an edge that is defined by a portion extending in the tire width direction and a portion extending in the tire radial direction, and that is located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.
